(19) United States
(12) Patent Application Publication
(10) Pub. No.: US 2009/0190782 A1
(43) Pub. Date: Jul. 30, 2009

(54) Vibration transducer

(75) Inventors: Tamito Suzuki, Fukuroi-shi (JP); Yukitoshi Suzuki, Hamamatsu-shi (JP); Toshihisa Suzuki, Hamamatsu-shi (JP); Akiyoshi Sato, Hamamatsu-shi (JP)

Correspondence Address: PILLSBURY WINTHROP SHAW PITTMAN LLP, P.O BOX 10500, McLean, VA, 22102, US

(73) Assignee: Yamaha Corporation, Hamamatsu-shi (JP)

(21) Appl. No.: 12/284,776

(22) Filed: Sep. 25, 2008

(30) Foreign Application Priority Data
Sep. 28, 2007 (JP) 2007-256908
Oct. 29, 2007 (JP) 2007-280315

(51) Int. Cl. H04R 11/04

(52) U.S. Cl. 381/174

(57) ABSTRACT

A vibration transducer includes a substrate, a diaphragm formed using deposited films having conductive property, which has a plurality of arms extended from the center portion in a radial direction, a plate formed using deposited films having conductive property, and a plurality of diaphragm supports formed using deposited films, which join the arms so as to support the diaphragm above the substrate with a prescribed gap therebetween. A plurality of bumps is formed in the arms of the diaphragm so as to prevent the diaphragm from being attached to the substrate or the plate. When the diaphragm vibrates relative to the plate, an electrostatic capacitance therebetween is varied so as to detect variations of pressure applied thereto. In addition, a plurality of diaphragm holes is appropriately aligned in the arms of the diaphragm so as to improve the sensitivity while avoiding the occurrence of adherence.

### BACKGROUND OF THE INVENTION

1. Field of the Invention

The present invention further relates to vibration transducers such as miniature condenser microphones serving as MEMS sensors.

The present application claims priority on Japanese Patent Application No. 2007-256908 and Japanese Patent Application No. 2007-280315, the contents of which are incorporated herein by reference in their entirety.

2. Description of the Related Art

Conventionally, various types of condenser microphones have been developed and disclosed in various documents as follows:

Patent Document 1: Japanese Patent Application Publication No. H09-508777

Patent Document 2: Japanese Patent Application Publication No. 2004-506394

Patent Document 3: U.S. Pat. No. 4,776,019

Non-Patent Document 1: The paper entitled “MSS-01-34” published by the Japanese Institute of Electrical Engineers

It is conventionally known that miniature condenser microphones (referred to as MEMS microphones) are produced by way of semiconductor device manufacturing processes. A typical example of the condenser microphone is produced by depositing thin films on a substrate so as to form a diaphragm and a plate, which serve as opposite electrodes slightly distanced from each other above the substrate. When the diaphragm vibrates due to sound waves, the displacement thereof causes variations of electrostatic capacitance, which are then converted into electric signals.

The distances between the diaphragm, the plate, and substrate are very small and may be set to several micro-meters (μm). When an impact is applied to the diaphragm, or when the diaphragm unexpectedly comes into contact with the plate or the substrate during manufacturing, adhesion (or stiction) in which the diaphragm becomes fixed to the plate or the substrate may occur. In order to improve the sensitivity, it is necessary to reduce the rigidity of the diaphragm; however, the adhesion may frequently occur as the rigidity of the diaphragm decreases.

### SUMMARY OF THE INVENTION

It is an object of the present invention to provide a vibration transducer such as a miniature condenser microphone, which prevents a diaphragm from being attached to a plate or a substrate during manufacturing and which thus improves sensitivity.

In a first third aspect of the present invention, a vibration transducer includes a substrate, a diaphragm formed using deposited films having conductive property, which has a plurality of arms extended from the center portion thereof in the radial direction; a plate formed using deposited films having conductive property, a plurality of diaphragm supports formed using deposited films, which join the arms so as to support the diaphragm above the substrate with a prescribed gap therebetween, and a plurality of diaphragm bumps, which are formed to project from the arms so as to prevent the diaphragm from being unexpectedly adhered to the substrate or the plate. When the diaphragm vibrates relative to the plate, an electrostatic capacitance therebetween varies so as to detect variations of pressure applied thereto. Instead of the diaphragm bumps, it is possible to form a plurality of plate bumps which project from the peripheral portion of the plate so as to prevent the diaphragm from being unexpectedly adhered to the plate.

In the vibration transducer, the peripheral portion of the diaphragm joins the substrate in a ring-shaped manner such that the arms extended from the center portion in the radial direction are supported by the diaphragm supports. Compared with another structure of the diaphragm whose peripheral portion simply joins the substrate in a ring-shaped manner, this diaphragm is reduced in rigidity, thus improving the sensitivity. Generally speaking, the amplitude of vibration becomes smaller in the direction from the center to the distal end (or fixed end), so that it is difficult for the fixed end of the diaphragm to become adhered to the substrate. In this sense, it may be necessary to provide some countermeasure with respect to the arms of the diaphragm that are reduced in rigidity. That is, a plurality of projections (namely, diaphragm bumps or plate bumps) is additionally formed so as to prevent the diaphragm from being unexpectedly adhered to the substrate or the plate. This outstanding structure can reliably prevent the occurrence of adherence of the diaphragm while improving the sensitivity of the vibration transducer.

The distal ends of the arms of the diaphragm may be easily curved or bent and are thus unexpectedly adhered to the substrate or the plate. Therefore, it is preferable that the projections be formed in proximity to the distal ends of the arms of the diaphragm.

The rigidity of the film(s) may be locally increased in prescribed regions corresponding to projections. When projections are formed and linearly aligned along multiple lines in the arms of the diaphragm with relatively large distances therebetween, the arms of the diaphragm may be irregularly distributed in rigidity in a striped manner, wherein one region having a relatively high rigidity and another region having a relatively low rigidity may alternately appear in the arms of the diaphragm in the radial direction. That is, the arms of the diaphragm may be easily bent at some regions each having a relatively low rigidity. When the arms are unexpectedly bent, the diaphragm may be easily adhered to the substrate or plate. To cope with such a drawback, the projections must be preferably aligned in the arms of the diaphragm in such a way that the line connecting between one projection and a proximate projection thereof in the radial direction be inclined about the circumferential direction of the diaphragm. This prevents the rigidity of the arms from being distributed in a striped manner.

It is preferable that the projections be aligned in a zigzag manner, thus preventing the rigidity of the arms from being distributed in a striped manner. The zigzag alignment differs from the lattice-like alignment in which all the projections are regularly aligned in both the radial direction and the circumferential direction. In other words, when the projections are aligned along two lines in the circumferential direction and are positioned at grid-like points, other projections are formed in such a way that at least one of them is not aligned in the radial direction together with at least one of the projections aligned along two lines.

In the above, it is preferable that each projection does not have a sharp distal end, which may damage the substrate or the plate. When the plate does not have an adequate hardness, the plate may be easily cracked or damaged due to impact with the “sharp” distal ends of the projections.

In a second aspect of the present invention, a vibration transducer includes a diaphragm having a conductive property, which is constituted of a center portion and a plurality of arms extended in the radial direction from the center portion, a plate having a conductive property, which is positioned opposite to the diaphragm, a plurality of diaphragm supports each having an insulating property, wherein the diaphragm supports join the arms so as to support the diaphragm while forming a gap between the diaphragm and the plate, and a plurality of holes which is formed in each of the arms of the diaphragm, wherein when the diaphragm vibrates relative to the plate, an electrostatic capacitance formed between the diaphragm and the plate varies, thus detecting vibration.

Since the external portion of the diaphragm is not supported in a ring-shaped manner but the arms are supported by the diaphragm supports, the diaphragm is partially reduced in rigidity so as to improve the sensitivity of the vibration transducer. In addition, the arms of the diaphragm are further reduced in rigidity due to the holes formed therein; hence, it is possible to further improve the sensitivity.

Stress may be concentrated at the boundaries between the arms and the center portion of the diaphragm due to sharp variations of the rigidity occurring in the boundaries, so that the arms may be easily bent or broken. When the diaphragm is bent at the boundaries between the arms and the center portion, the diaphragm may be easily attached (or adhered) to the plate and the like. To avoid such a drawback, it is preferable that the density of each arm gradually increase in the direction from the joint portion of the arm joining with the diaphragm support to the center portion of the diaphragm by means of the holes aligned in each arm. Herein, the density of the arm is defined as “Va/(Va+Vc)” with respect to the prescribed area of the arm, wherein Va designates the volume of the arm excluding the holes, and Vc designates the total volume of the holes formed in the arm.

The vibration transducer further includes a substrate having an opening forming a back cavity with the diaphragm, wherein the diaphragm supports join the surrounding area of the opening of the substrate, wherein the center portion of the diaphragm substantially covers the opening of the substrate with a gap therebetween, and wherein the holes are formed in each arm except for the prescribed area positioned in proximity to the opening of the substrate.

In the above, a relatively high acoustic resistance should be formed between the diaphragm and the substrate in proximity to the surrounding area of the opening of the back cavity. The vibration transducer is designed such that an acoustic resistance is formed between the diaphragm and the surrounding area of the opening of the substrate, while no hole is formed in the arms in the regions positioned in proximity the opening; thus, it is possible to increase the acoustic resistance in the gap between the arms of the diaphragm and the substrate. In other words, it is possible to increase the rigidity of the diaphragm without reducing the acoustic resistance in the gap between the diaphragm and the substrate in proximity to the surrounding area of the opening of the back cavity.

When the holes are aligned in the arms of the diaphragm along multiple lines in the circumferential direction of the diaphragm, stripe-shaped irregularities may occur in the distribution of rigidity of the arms of the diaphragm, wherein stripe-shaped regions having high rigidity and other stripe-shaped regions having low rigidity are alternately formed in the diaphragm in the radial direction. That is, the arm of the diaphragm may be easily bent at the stripe-shaped region having low rigidity, whereby the diaphragm may be easily attached (or adhered) to the plate when the arm is bent. For this reason, it is preferable that the line connecting between the holes adjoining in the radial direction be inclined to the circumferential direction of the diaphragm. Due to such alignment of the holes formed in the arms of the diaphragm, the stripe-shaped regions having low rigidity due to the holes are inclined to the circumferential direction of the diaphragm. This makes it very difficult for the arms to be bent along the circumferential direction of the diaphragm. That is, it is possible to reliably prevent the diaphragm from being attached to the plate due to bending of the arms.

In addition, each arm is reduced in density in the direction from the center of each arm in the circumferential direction of the diaphragm to the edges of each arm. Herein, tensile stress is not directly exerted on the arm in the width direction, so that the edges of the arm in the width direction (i.e., in the circumferential direction of the diaphragm) may be easily wound due to stress occurring during the formation of the diaphragm. The diaphragm is easily attached to the plate when the arms are wound. The vibration transducer is designed such that the edges of the arm are hardly wound in the width direction since the density of the arm decreases in the direction towards the edges of the arm in the width direction. This makes it possible to prevent the arms of the diaphragm from being attached to the plate due to winding of the arms.

Moreover, it is preferable that at least a part of the area of each arm which is close to the center portion of the diaphragm compared with the joint portion joining with the diaphragm support be formed in a net-like shape. Due to the net-like shape in which numerous holes are formed in the arm such that the distance between the adjacent holes substantially matches the diameter of each hole, it is possible to remarkably reduce the rigidity of the arms of the diaphragm.

### BRIEF DESCRIPTION OF THE DRAWINGS

These and other objects, aspects, and embodiments of the present invention will be described in more detail with reference to the following drawings.

FIG. 1 is a plan view showing a sensor chip of a condenser microphone, which is constituted of a diaphragm and a plate positioned opposite to each other above a substrate, in accordance with a first embodiment of the present invention.

FIG. 2 is a longitudinal sectional view showing the constitution of the condenser microphone.

FIG. 3 is an exploded perspective view showing the laminated structure of the condenser microphone.

FIG. 4A is a circuit diagram showing the circuitry of the condenser microphone having no guard electrode.

FIG. 4B is a circuit diagram showing the circuitry of the condenser microphone in which guard electrodes are inserted between the plate and the substrate.

FIG. 5 is a sectional view used for explaining a first step of a manufacturing method of the condenser microphone.

FIG. 6 is a sectional view used for explaining a second step of the manufacturing method of the condenser microphone.

FIG. 7 is a sectional view used for explaining a third step of the manufacturing method of the condenser microphone.

FIG. 8 is a sectional view used for explaining a fourth step of the manufacturing method of the condenser microphone.

FIG. 9 is a sectional view used for explaining a fifth step of the manufacturing method of the condenser microphone.

FIG. 10 is a sectional view used for explaining a sixth step of the manufacturing method of the condenser microphone.

FIG. 11 is a sectional view used for explaining a seventh step of the manufacturing method of the condenser microphone.

FIG. 12 is a sectional view used for explaining an eighth step of the manufacturing method of the condenser microphone.

FIG. 13 is a sectional view used for explaining a ninth step of the manufacturing method of the condenser microphone.

FIG. 14 is a sectional view used for explaining a tenth step of the manufacturing method of the condenser microphone.

FIG. 15 is a sectional view used for explaining an eleventh step of the manufacturing method of the condenser microphone.

FIG. 16 is a sectional view used for explaining a twelfth step of the manufacturing method of the condenser microphone.

FIG. 17 is a sectional view used for explaining a thirteenth step of the manufacturing method of the condenser microphone.

FIG. 18 is an enlarged view showing an arm having diaphragm holes and diaphragm bumps.

FIG. 19 is an enlarged view showing a variation of the arm with regard to the alignment of diaphragm bumps.

FIG. 20 is an enlarged view showing another variation of the arm with regard to the alignment of diaphragm bumps.

FIG. 21 is a cross-sectional view showing a prescribed part of the condenser microphone shown in FIG. 2.

FIG. 22 is a cross-sectional view showing another part of the condenser microphone shown in FIG. 2.

FIG. 23 is a plan view showing a sensor chip of a condenser microphone, which is constituted of a diaphragm and a plate positioned opposite to each other above a substrate, in accordance with a second embodiment of the present invention.

FIG. 24 is an exploded perspective view showing the laminated structure of the condenser microphone shown in FIG. 23.

FIG. 25 is a plan view of an arm of the diaphragm having diaphragm holes and diaphragm bumps.

FIG. 26 is a plan view of the arm of a first variation.

FIG. 27 is a plan view of the arm of a second variation.

FIG. 28 is a plan view of the arm of a third variation.

FIG. 29 is a plan view of the arm of a fourth variation.

FIG. 30 is a plan view of the arm of a fifth variation.

FIG. 31 is a plan view of the arm of a sixth variation.

### DESCRIPTION OF THE PREFERRED EMBODIMENTS

The present invention will be described in further detail by way of examples with reference to the accompanying drawings.

### 1. First Embodiment

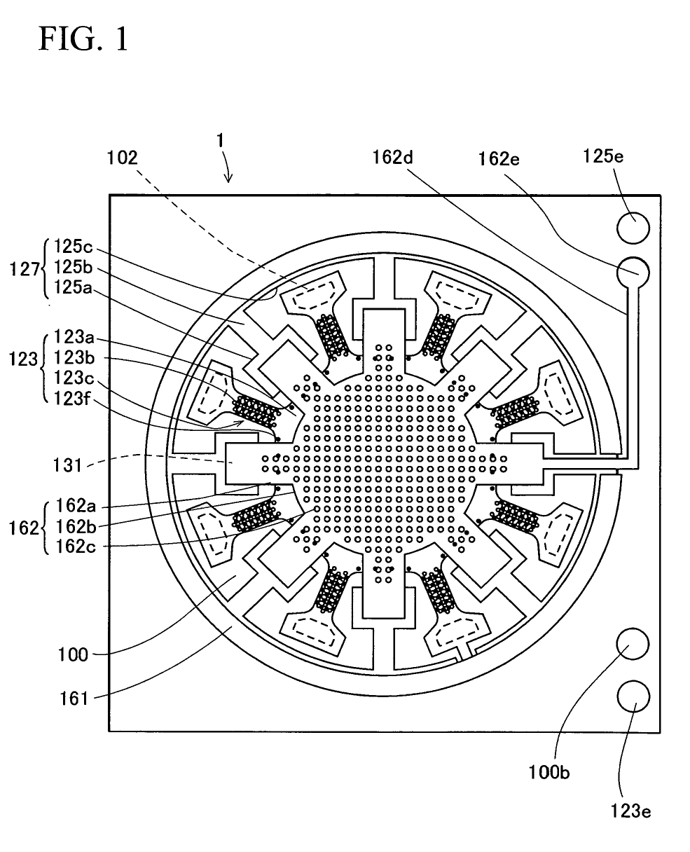

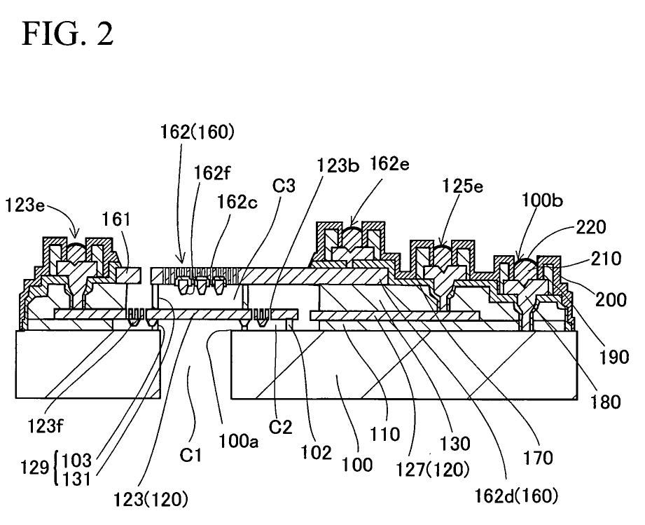

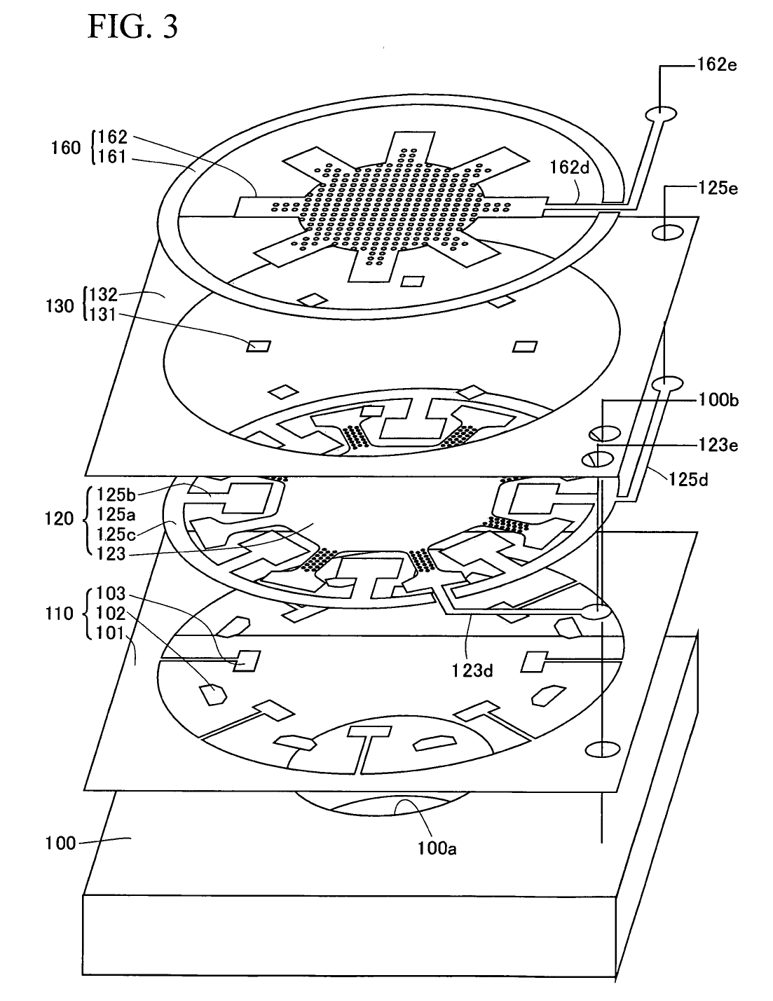

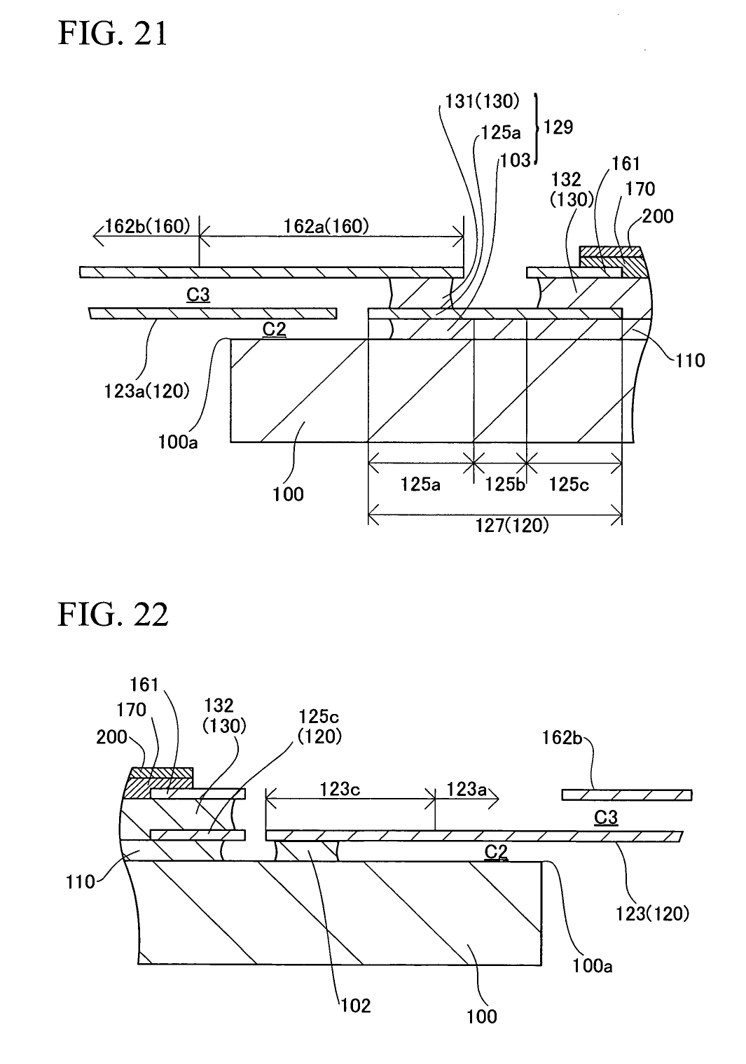

FIG. 1 is a plan view showing a sensor chip of a condenser microphone 1 having an MEMS (Micro-Electro-Mechanical System) structure in accordance with a third embodiment of the present invention. FIG. 2 is a longitudinal sectional view showing the constitution of the condenser microphone 1. FIG. 3 is an exploded perspective view showing the laminated structure of the condenser microphone 1. FIGS. 21 and 22 are cross-sectional views showing prescribed parts of the condenser microphone 1.

The condense microphone 1 is constituted of the sensor chip and a control chip (which includes a power supply circuit and an amplifier, not shown), both of which are encapsulated in a package (not shown).

The sensor chip of the condenser microphone 1 is formed by depositing multiple films on a substrate 100, namely, a lower insulating film 110, a lower conductive film 120, an upper insulating film 130, an upper conductive film 160, and a surface insulating film 170. First, the laminated structure of multiple films in the MEMS structure will be described below.

The substrate 100 is composed of P-type monocrystal silicon; but this is not a restriction. That is, it is simply required that the material of the substrate 100 have adequate rigidity, thickness, and hardness for reliably supporting thin films deposited on the base. A through-hole having an opening 100a (serving as an opening of a back cavity C1) is formed to run through the substrate 100 at a prescribed position.

The lower insulating film 110 (which joins the substrate 100, the lower conductive film 120, and the upper insulating film 130) is a deposited film composed of silicon oxide (SiOx). The lower insulating film 110 forms a plurality of diaphragm supports 102 (which are disposed in the circumference with the same distance therebetween), a plurality of guard spacers 103 (which are disposed in the circumference with the same distance therebetween and are arranged inwardly of the diaphragm supports 102), and a ring-shaped portion 101 (which insulates a guard ring 125c and a guard lead 125d from the substrate 100).

The lower conductive film 120 (which joins the lower insulating film 110 and the upper insulating film 130) is a deposited film composed of polycrystal silicon entirely doped with impurities such as phosphorus (P). The lower conductive film 120 forms a diaphragm 123 and a guard 127 which is constituted of guard electrodes 125a and guard connectors 125b as well as the guard ring 125c and the guard lead 125d.

The upper insulating film 130 (which joins the lower conductive film 120, the upper conductive film 160, and the lower insulating film 110) is a deposited film composed of silicon oxide. The upper insulating film 130 forms a plurality of plate spacers 131 (which are disposed in the circumference with prescribed distances therebetween) and a ring-shaped portion 132 (which is positioned outside of the plate spacers 131 so as to support an etching stopper ring 161 and to insulate a plate lead 162d from the guard lead 125d.

The upper conductive film 160 (which joins the upper insulating film 130) is a deposited film composed of polycrystal silicon entirely doped with impurities such as phosphorus (P). The upper conductive film 160 forms a plate 162 as well as the plate lead 162d and the etching stopper ring 161.

The surface insulating film 170 (which joins the upper conductive film 160 and the upper insulating film 130) is a deposited film (having an insulating property) composed of silicon oxide.

The MEMS structure of the condenser microphone 1 has four terminals, i.e., terminals 125e, 162e, 123e, and 100b. The terminals 125e, 162e, 123e, and 100b are each formed using a pad conduction film 180 (which is a deposited film having a conductive property composed of AlSi), a bump film 210 (which is a deposited film having a conductive property composed of Ni), and a bump protection film 220 (which is a deposited film having a conductive property and a superior corrosion resistance composed of Au). The terminals 125e, 162e, 123e, and 100b are each protected by side walls that are formed using a pad protection film 190 (which is a deposited film having an insulating property composed of SiN) and a surface protection film 200 (which is a deposited film having an insulating property composed of silicon oxide).

The MEMS structure of the condenser microphone 1 has the laminated structure of films as described above.

Next, the mechanical structure of the MEMS structure of the condenser microphone 1 will be described in detail.

The diaphragm 123 is composed of a single thin deposited film entirely having a conductive property and is constituted of a center portion 123a and a plurality of arms 123c (which are extended in radial directions externally from the center portion 123a). The diaphragm 123 is positioned in parallel with the substrate 100 and is supported by means of the “pillar” diaphragm supports 102 (which join the periphery of the diaphragm 123 at prescribed positions) in such a way that the diaphragm 123 is insulated from the plate 162, by which prescribed gaps are formed between the diaphragm 123 and the plate 162 and between the diaphragm 123 and the substrate 100. The diaphragm supports 102 join the distal ends of the arms 123c of the diaphragm 123. Due to cutouts formed between the arms 123c, the peripheral portion of the diaphragm 123 is reduced in rigidity compared with a conventional diaphragm having no cutout (not shown). A plurality of diaphragm holes 123b is formed to run through a plurality of arms 123c, which is thus reduced in rigidity.

Each arm 123c is gradually increased in width dimensions in the circumferential direction of the diaphragm 123 in proximity to the center portion 123a. This reduces the concentration of stress applied to the boundary between the center portion 123a and the arms 123c. Since no bent portion is formed in the outlines of the arms 123c in proximity to the boundary between the center portion 123a and the arms 123c, it is possible to prevent stress from being concentrated at the bent portion.

The arms 123c of the diaphragm 123 are increased in width dimensions in the circumferential direction at joining regions with the diaphragm supports 102. Specifically, the arms 123c of the diaphragm 123 are gradually reduced in width dimensions externally from the center portion 123a, while they are gradually increased in width dimensions in proximity to the diaphragm supports 102. That is, the width of the arm 123c (lying in the circumferential direction of the diaphragm 123) becomes shortest in the area between the center portion 123a and the diaphragm support 102, while it becomes longer in the joining region with the diaphragm support 102 compared with the shortest width of the arm 123c established in the area between the center portion 123a and the diaphragm support 102. For this reason, it is possible to increase the durability of the diaphragm 123 by increasing the joining regions between the arms 123c and the diaphragm supports 202 without increasing the radius of the diaphragm 123. The arms 123c have the longest width (lying in the circumferential direction of the diaphragm 123) at the joining regions with the diaphragm supports 102; hence, it is possible to adequately secure the joining strength of the diaphragm 123 irrespective of a relatively low rigidity of the diaphragm 123.

The diaphragm supports 102 are disposed with the same distance therebetween in the circumferential periphery of the opening 100a of the back cavity C1. The diaphragm supports 102 are each composed of a deposited film having an insulating property and a pillar shape. The diaphragm 123 is supported above the substrate 100 by the diaphragm supports 102 such that the center portion 123a covers the opening 100a of the back cavity C1. The diaphragm supports 102 are positioned between joint portions 162a of the plate 162 and are positioned externally from a plate support 129 in the radial direction of the plate 162; hence, the rigidity of the diaphragm 123 is lower than the rigidity of the plate 162. The width of the diaphragm support 102 (lying in the circumferential direction of the diaphragm 123) is longer than the width of the arm 123c in the area between the center portion 123a and the diaphragm support 102. This secures an adequate joining strength between the diaphragm 123 and the diaphragm supports 102. A gap C2 (whose height substantially matches the height of the diaphragm supports 102) is formed between the substrate 100 and the diaphragm 123. The gap C2 is necessary to establish balance between the internal pressure of the back cavity C1 and the atmospheric pressure. The gap C2 is formed to have a low height and a longer length (lying in the radial direction of the diaphragm 123), thus forming a maximum acoustic resistance in the path via which sound waves vibrating the diaphragm 123 reach the opening 100a of the back cavity C1.

A plurality of diaphragm bumps 123f are formed on the backside of the diaphragm 123 positioned opposite the substrate 100. The positions of the diaphragm bumps 123f are indicated by black dots in FIG. 1. The diaphragm bumps 123f are projections for avoiding adherence of the diaphragm 123, in which the diaphragm 123 is unexpectedly adhered to the substrate 100. They are formed using the waviness of the lower conductive film 120 forming the diaphragm 123. In other words, dimples (or small recesses) are formed on the surface of the diaphragm 123 in correspondence with the diaphragm bumps 123f.

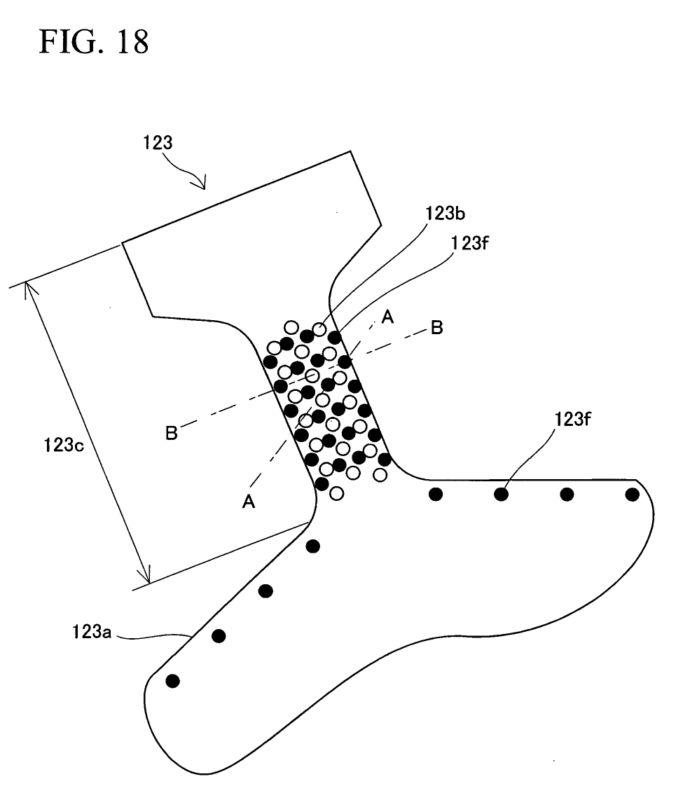

FIG. 18 is an enlarged view showing a prescribed part of the diaphragm 123, i.e. the arm 123c and its associated parts, wherein black dots indicate the diaphragm bumps 123f.

A forked portion between the adjacent arms 123c in the peripheral portion of the center portion 123a of the diaphragm 123 is reduced in tension and is thus easily subjected to irregular vibration, wherein it may be easily curved or bent due to stress during the formation of the diaphragm 123. For this reason, the diaphragm bumps 123f are arranged in the forked portion between the adjacent arms 123c in the peripheral portion of the center portion 123a of the diaphragm 123. It is preferable that the distance between the diaphragm bump 123f (formed in the peripheral portion of the center portion 123a) and the peripheral end of the center portion 123a be as short as possible. Specifically, the shortest distance between the diaphragm bump 123f (formed in the peripheral portion of the center portion 123a) and the peripheral end of the center portion 123a be smaller than the maximum distance between the diaphragm 123 and the plate 162 and be shorter than the height of the diaphragm bump 123f. Due to the formation of the diaphragm bumps 123f formed in the peripheral portion of the center portion 123a of the diaphragm 123, it is possible to prevent the center portion 123a from being unexpectedly adhered to the substrate 100. In this connection, when the diaphragm bumps 123f are formed to project towards the plate 162, it is possible to prevent the center portion 123a of the diaphragm 123 from being unexpectedly adhered to the plate 162.

Since the arms 123c are reduced in rigidity compared with the center portion 123a of the diaphragm 123, they may be easily vibrated irrespective of relatively short distances between the arms 123c and the diaphragm supports 202 (which form fixed ends of the diaphragm 123). To cope with such an event, the diaphragm bumps 123f are aligned in the arms 123c as well. The arms 123c may be easily curved or bent at the edges thereof lying in the width direction due to stress during the formation of the diaphragm 123. For this reason, the diaphragm bumps 123f are linearly aligned along the opposite edges (lying in the width direction or the circumferential direction) of the arms 123c in the radial direction. It is preferable that the distance between the diaphragm bump 123f (formed along the edge of the arm 123c) and the edge of the arm 123c in the width direction be as short as possible. Specifically, it is preferable that the distance between the diaphragm bump 123f (formed along the edge of the arm 123c) and the edge of the arm 123c in the width direction be shorter than the maximum distance between the diaphragm 123 and the plate 162 and be shorter than the height of the diaphragm bump 123f. It is preferable that the diaphragm bumps 123f (formed along the edge of the arm 123c) be positioned closer to the edge of the arm 123c in the width direction compared with the diaphragm holes 123b (see white dots in FIG. 18) formed in the arm 123c. Due to the formation of the diaphragm bumps 123f formed in the arms 123c, it is possible to prevent the arms 123c of the diaphragm 123 from being unexpectedly adhered to the substrate 100.

In order to prevent the arm 123c from being easily bent, the diaphragm bumps 123f are aligned in two lines in the center area of the arm 123c in the radial direction. That is, four lines of the diaphragm bumps 123f in total are aligned in the arm 123c in such a way that the diaphragm bumps 123c of two lines aligned along the opposite edges of the arm 123c are arranged alternately with the diaphragm bumps 123c of two lines aligned in the center area of the arm 123c. That is, the diaphragm bumps 123c are aligned in four lines in a zigzag manner in such a way that the direction (designated by A-A in FIG. 18) connecting the diaphragm bumps 123c adjoining together in the radial direction is inclined with respect to the circumferential direction (designated by B-B in FIG. 18) of the diaphragm 123. In other words, a tangential line (i.e. line B-B) is drawn in connection with one diaphragm bump 123c (which is positioned at a point of tangency along the circumference drawn about the center of the diaphragm 123) while a straight line (i.e. line A-A) connects one diaphragm bump 123f to another diaphragm bump 123f (which is proximate to one diaphragm bump 123f in the radial direction), wherein the line A-A is inclined about the line B-B. Since the diaphragm bumps 123f are aligned in a zigzag manner in the arm 123c as shown in FIGS. 1 and 18, it is possible to prevent the arm 123c from being easily bent, thus preventing the arm 123c from being unexpectedly adhered to the substrate 100.

In order to prevent the substrate 100 and/or the plate 162 from being unexpectedly damaged due to the contact with the diaphragm bumps 123f, it is preferable that the distal ends of the diaphragm bumps 123f not be formed in sharp shapes. Specifically, it is preferable that the distal ends of the diaphragm bumps 123f each be formed in a planar shape or a spherical shape.

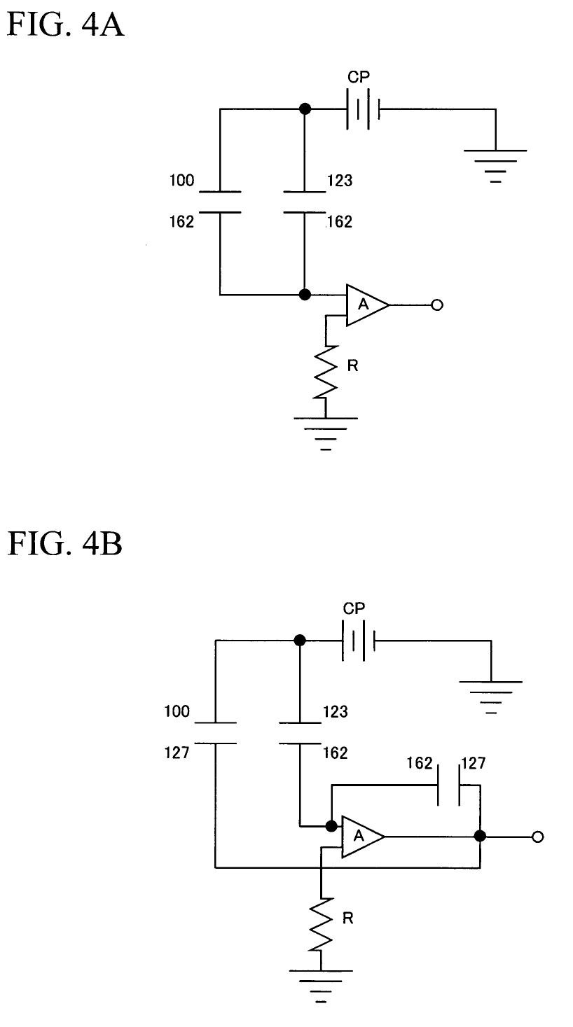

The diaphragm lead 123d is extended from the distal end of one of the arms 123c of the diaphragm 123 and is connected to the terminal 123e. The diaphragm lead 123d is reduced in width dimension compared with the arm 123c and is formed using the lower conductive film 120 in a similar manner to the diaphragm 123. The diaphragm lead 123d is positioned at a split area of the ring-shaped guard ring 125c and is elongated towards the terminal 123e. Since the terminal 123e of the diaphragm 123 is short-circuited with the terminal 100b of the substrate 100 in a control chip (see FIGS. 4A and 4B), both the diaphragm 123 and the substrate 100 are applied with substantially the same potential.

When the diaphragm 123 differs from the substrate 100 in potential, a parasitic capacitance may occur between the diaphragm 123 and the substrate 100. Since the diaphragm 123 is supported using the diaphragm supports 102 so that air layers may be formed between the adjacent diaphragm supports 102, it is possible to remarkably reduce the parasitic capacitance compared with another structure in which the diaphragm 123 is supported by a ring-shaped spacer.

The plate 162 is composed of a single thin deposited film substantially having a conductive property and is constituted of a center portion 162b and a plurality of joint portions 162a (which are elongated externally from the center portion 162b in the radial direction). The plate 162 is supported by a plurality of plate spacers 131 having pillar shapes, which join the peripheral portion of the plate 162. The plate 162 is positioned in parallel with the diaphragm 123 in such a way that the center thereof vertically overlaps the center of the diaphragm 123. The distance between the center of the center portion 162b and the peripheral end of the center portion 162b, in other words, the shortest distance between the center and the peripheral end of the plate 162, is shorter than the distance between the center of the center portion 123a and the peripheral end of the center portion 123a, in other words, the shortest distance between the center and the peripheral end of the diaphragm 123. For this reason, the plate 162 is not positioned opposite to the peripheral portion of the diaphragm 123 which may vibrate with relatively small amplitude. A plurality of cutouts is formed between the adjacent joint portions 162a in the plate 162, wherein the cutouts vertically overlap the peripheral portion of the diaphragm 123; hence, the plate 162 is not positioned opposite to the peripheral portion of the diaphragm 123. The arms 123c are extended in the areas vertically corresponding to the cutouts of the plate 162. This increases the effective length of the diaphragm 123, i.e. the distance between the vibrating ends of the diaphragm 123, without increasing the parasitic capacitance formed between the diaphragm 123 and the plate 162.

A plurality of plate holes 162c (each running through the plate 162) is formed in the plate 162. The plate holes 162c serve as passages allowing sound waves to propagate therethrough towards the diaphragm 123, while they also serve as holes allowing etchant (used for isotropic etching of the upper insulating film 130) to transmit therethrough. Prescribed parts of the upper insulating film 130 (which remain after etching) form the plate spacers 131 and the ring portion 132, while other parts (which are removed by etching) form a gap C3 between the diaphragm 123 and the plate 162. That is, the plate holes 162c allow etchant to transmit therethrough and to reach the upper insulating film 130, thus making it possible to simultaneously form the gap C3 and the plate spacers 131. For this reason, the plate holes 162c are appropriately arranged in the plate 162 in consideration of the height of the gap C3, the shapes of the plate spacers 131, and the etching speed. Specifically, the plate holes 162b are aligned with the same distance therebetween in the overall areas of the center portion 162b and the joint portions 162a except for the joining regions of the plate spacers 131 and their circumferential regions. As the distance between the adjacent plate holes 162c is reduced to be smaller, the width of the ring portion 132 of the upper insulating film 130 is reduced so as to reduce the overall area of the sensor chip. However, the rigidity of the plate 162 is reduced as the distance between the adjacent plate holes 162c is reduced.

The plate spacers 131 join the guard electrodes 125a (which are placed in the same layer as the diaphragm 123), wherein the guard electrodes 125a are formed using the lower conductive film 120 in a similar manner to the diaphragm 123. The plate spacers 131 are formed using the upper insulating film 130 having an insulating property, which joins the plate 162. The plate spacers 131 are aligned with the same distance therebetween in the surrounding area of the opening 100a of the back cavity C1. The plate spacers 131 are positioned to vertically overlap the cutouts between the adjacent arms 132c of the diaphragm 132. This makes it possible to reduce the maximum diameter of the diaphragm 123 to be smaller than the maximum diameter of the plate 162. This increases the rigidity of the plate 162 and reduces the parasitic capacitance between the plate 162 and the substrate 100.

The plate 162 is supported above the substrate 100 by means of a plurality of plate supports 129 having pillar shapes, which are constituted of the guard spacers 103, the guard electrodes 125a, and the plate spacers 131. In the present embodiment, the plate supports 129 are composed of multiple deposited layers. By way of the plate spacers 129, the gap C3 is formed between the plate 162 and the diaphragm 123, while the gaps C3 and C2 are formed between the plate 162 and the substrate 100. Since both the guard spacers 103 and the plate spacers 131 have insulating properties, the plate 162 is insulated from the substrate 100.

When the guard electrodes 125a are excluded from the sensor chip of the condenser microphone 1 so that the potential of the plate 162 differs from the potential of the substrate 100, a parasitic capacitance occurs between the plate 162 and the substrate 100 positioned opposite to each other. The parasitic capacitance may increase when an insulating substance exists between the plate 162 and the substrate 100 (see FIG. 4A). In the present embodiment, the plate 162 is supported above the substrate 100 by means of the plate supports 129, which are distanced from each other and which are constituted of the guard spacers 103, the guard electrodes 125a, and the plate spacers 131. Hence, even when the guard electrodes 125a are excluded from the present embodiment, it is possible to remarkably reduce the parasitic capacitance in comparison with another structure in which the plate 162 is supported above the substrate 100 by means of a ring-shaped-wall-like insulating member.

A plurality of plate bumps (or projections) 162f is formed on the backside of the plate 162 (which is positioned opposite to the diaphragm 123). The plate bumps 162f are formed using a silicon nitride (SiN) film joining the upper conductive film 160 (forming the plate 162) and a polycrystal silicon film (joining the silicon nitride film). The plate bumps 162 prevent the diaphragm 123 from being unexpectedly adhered to the plate 162.

A plate lead 162d (whose width is smaller than the width of the joint portion 162a) is extended from the distal end of one of the joint portions 162a of the plate 162 towards the terminal 162e. The plate lead 162d is formed using the upper conductive film 160 in a similar manner to the plate 162. The wiring path of the plate lead 162d substantially overlaps with the wiring path of the guard lead 125d. This reduces the parasitic capacitance between the plate lead 162d and the substrate 100.

Next, the operation of the condenser microphone 1 will be described in detail.

FIGS. 4A and 4B show examples of the circuitry including the sensor chip and the control chip. A charge pump CP installed in the control chip applies a stabilized bias voltage to the diaphragm 123. As the bias voltage increases, the sensitivity of the sensor chip increases; however, a high bias voltage may cause adherence between the diaphragm 123 and the plate 162; hence, the rigidity of the plate 162 is an important factor in designing the condenser microphone 1.

Sound waves entering into a through-hole of a package (not shown) propagate through the plate holes 162c and the cutouts between the joint portions 162a of the plate 162 so as to reach the diaphragm 132. Sound waves of the same phase may propagate along both the surface and backside of the plate 162; hence, the plate 162 does not substantially vibrate due to sound waves. Sound waves cause the diaphragm 132 to vibrate relative to the plate 162. Vibration of the diaphragm 132 varies electrostatic capacitance of a parallel-plate capacitor having opposite electrodes corresponding to the diaphragm 123 and the plate 162. Variations of electrostatic capacitance are converted into electric signals, which are then amplified by an amplifier A of the control chip. Since the output of the sensor chip has a high impedance, it is necessary to incorporate the amplifier A into the package.

Since the substrate 100 is short-circuited with the diaphragm 123, a parasitic capacitance may be formed between the substrate 100 and the plate 162 (which does not vibrate relative to the diaphragm 123) in the circuitry of FIG. 4A, which is an equivalent circuit of the condenser microphone M having no guard electrode 125a of the guard 127. In the circuitry of FIG. 4B, the output terminal of the amplifier A is connected to the guard 127 so as to form a voltage-follower circuit using the amplifier A, thus eliminating the parasitic capacitance between the substrate 100 and the plate 162. That is, by arranging the guard electrodes 125a in the areas between the substrate 100 and the joint portions 162a of the plate 162, which are positioned opposite to each other, it is possible to remarkably reduce the parasitic capacitance in the areas between the substrate 100 and the joint portions 162a of the plate 162. The guard lead 125d, which is extended from the guard ring 125c (for connecting the guard electrodes 125a together) towards the terminal 125e, is wired opposite to the plate lead 162d, which is extended from the joint portion 162a of the plate 162; hence, no parasitic capacitance is formed between the substrate 100 and the plate lead 162d. The ring-shaped guard ring 125c connects together the guard electrodes 125a with the shortest distance therebetween in the periphery of the diaphragm 123. By increasing the length of the guard electrode 125a to be longer than the length of the joint portion 162a of the plate 162 in the circumferential direction of the plate 162, it is possible to further reduce the parasitic capacitance.

In this connection, it is possible to form the condenser microphone 1 having only a single sensor chip which includes the aforementioned elements such as the charge pump CP and the amplifier A included in the control chip.

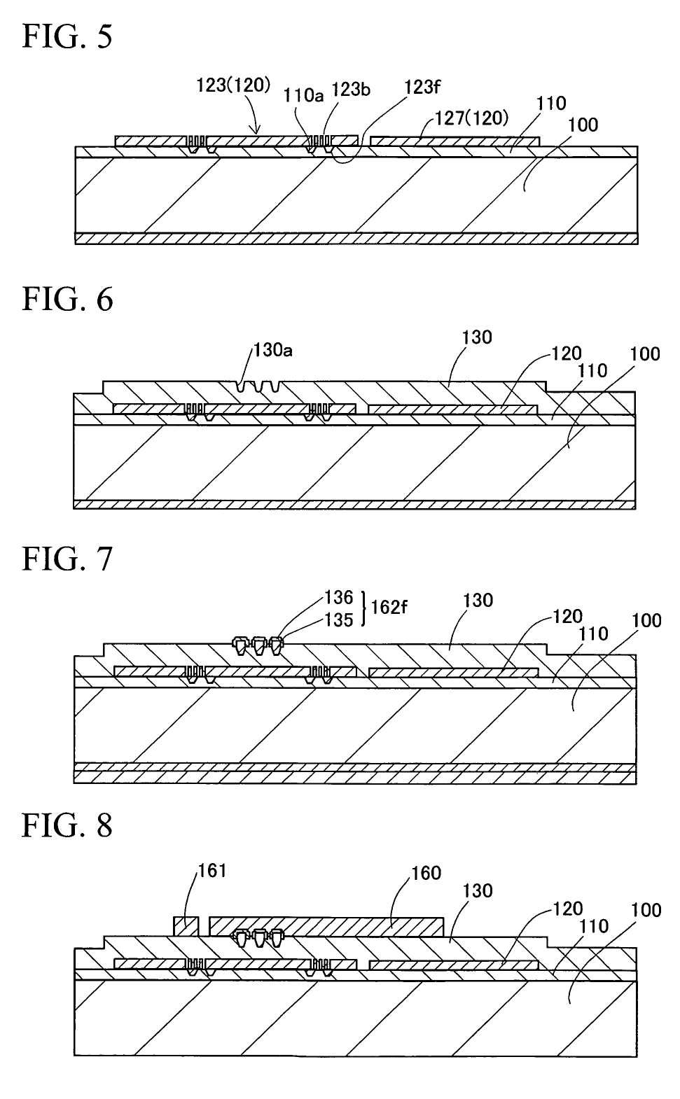

Next, a manufacturing method of the condenser microphone 1 will be described in detail with reference to FIGS. 5 to 17.

In a first step of the manufacturing method shown in FIG. 5, the lower insulating film 120 composed of silicon oxide is entirely formed on the surface of the substrate 100. Next, dimples 120a (used for the formation of the diaphragm bumps 123f) are formed in the lower insulating film 120 by way of etching using a photoresist mask. Herein, the bottoms of the dimples 120a are not formed in sharp shapes. For example, the dimples 120a are formed by way of isotropic etching, or anisotropic etching is stopped when planar bottoms are formed in the dimples 120a. Next, the lower conductive film 120 composed of polycrystal silicon is formed on the surface of the lower insulating film 120 by way of chemical vapor deposition (CVD). Thus, the diaphragm bumps 123f are formed in conformity with the dimples 120a. Lastly, the lower conductive film 120 is subjected to etching using a photoresist mask, thus forming the diaphragm 123 and the guard 127 (which are formed using the lower conductive film 120).

In a second step of the manufacturing method shown in FIG. 6, the upper insulating film 130 composed of silicon oxide is formed to entirely cover the surfaces of the lower insulating film 110 and the lower conductive film 120. Next, the dimples 130a (used for the formation of the plate bumps 162f) are formed on the upper insulating film 130 by way of etching using a photoresist mask.

In a third step of the manufacturing method shown in FIG. 7, the plate bumps 162f composed of a polycrystal silicon film 135 and silicon nitride film 136 are formed on the surface of the upper insulating film 130. The silicon nitride film 136 is formed after the patterning of the polycrystal silicon film 135 by way of a known method; hence, the exposed portions of the polycrystal silicon film 135, which project upwardly from the dimples 130a, are entirely covered with the silicon nitride film 136. The silicon nitride film 136 is an insulating film that prevents the diaphragm 132 from being short-circuited with the plate 162 when the diaphragm 132 is unexpectedly adhered to the plate 162.

In a fourth step of the manufacturing method shown in FIG. 8, the upper conductive film 160 composed of polycrystal silicon is formed on the exposed surface of the upper insulating film 130 and the surface of the silicon nitride film 136 by way of ECVD. Next, the upper conductive film 160 is subjected to etching using a photoresist mask, thus forming the plate 162, the plate lead 162d, and the etching stopper 161. In this step, the plate holes 162c are not formed in the plate 162.

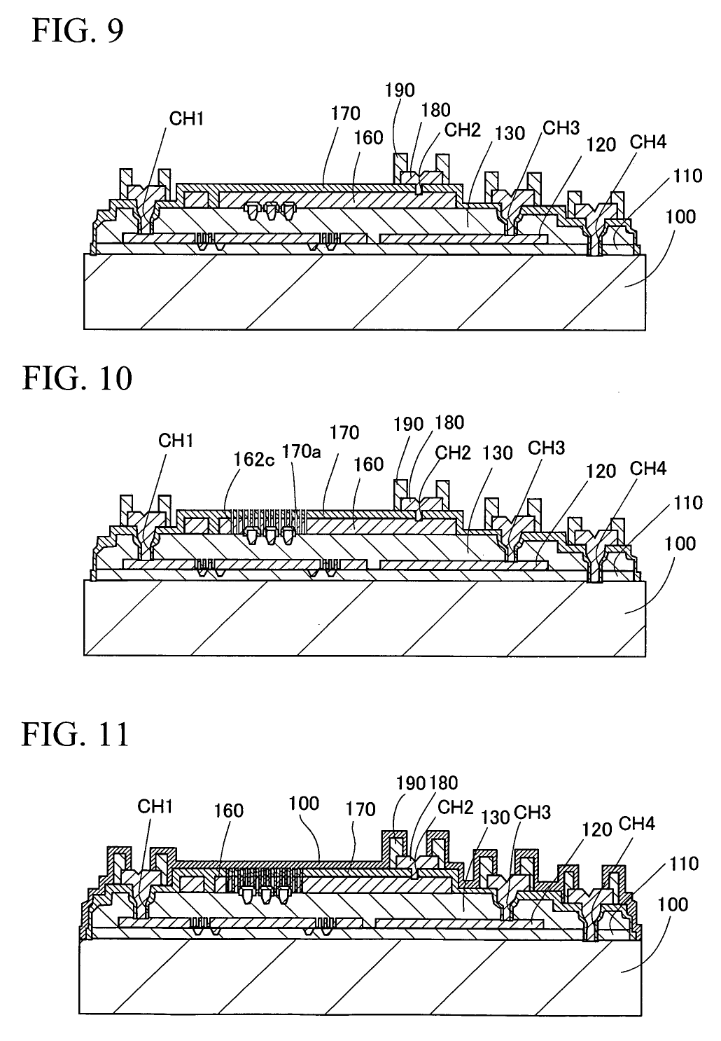

In a fifth step of the manufacturing method shown in FIG. 9, contact holes CH1, CH3, and CH4 are formed at prescribed positions of the upper insulating film 130. Subsequently, the surface insulating film 170 is formed to entirely cover the overall surface of the structure shown in FIG. 9. In addition, etching using a photoresist mask is performed so as to form a contact hole CH2 in the surface insulating film 170 and to simultaneously remove unnecessary substances formed in the bottoms of the contact holes CH1, CH3, and CH4 of the surface insulating film 170. Next, the pad conduction film 180 composed of AlSi is formed and embedded inside of the contact holes CH1, CH2, CH3, and CH4 and is then removed by way of patterning according to a known method, so that only prescribed parts thereof still remain in the contact holes CH1, CH2, CH3, and CH4. Furthermore, the pad protection film 190 composed of silicon nitride is formed on the surface insulating film 170 and the pad conduction film 180 by way of CVD and is then removed by way of patterning according to a known method, so that only prescribed parts thereof still remain in the surrounding areas of the pad conduction film 180.

In a sixth step of the manufacturing method shown in FIG. 10, anisotropic etching using a photoresist mask is performed so as to form through-holes 170a (corresponding to the plate holes 162c) running through the surface insulating film 170. Thus, the plate holes 162c are formed in the upper conductive film 160. This step is consecutively performed so that the surface insulating film 170 having the through-holes 170a serves as a resist mask for the upper conductive film 160.

In a seventh step of the manufacturing method shown in FIG. 11, the surface protection film 200 is formed to entirely cover the surfaces of the surface insulating film 170 and the pad protection film 190. In this step, the prescribed parts of the surface protection film 200 are embedded in the through-holes 170a of the surface insulating film 170 and the plate holes 162c.

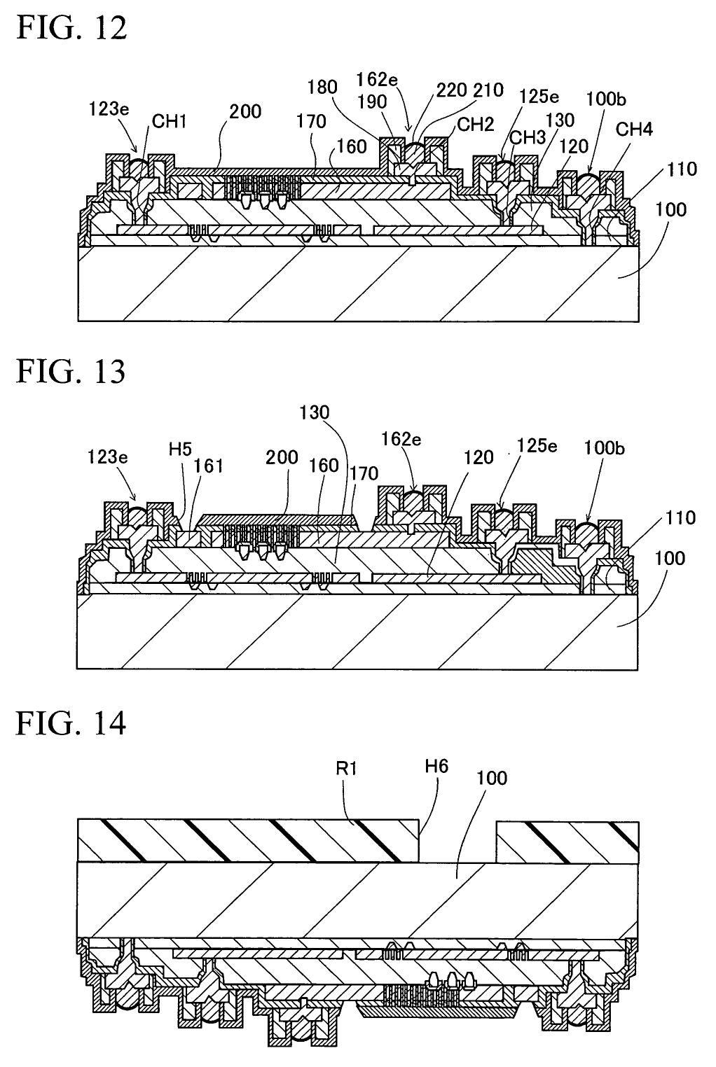

In an eighth step of the manufacturing method shown in FIG. 12, a bump film 210 composed of Ni is formed on the surface of the pad conduction film 180 formed in the contact holes CH1, CH2, CH3, and CH4; then, a bump protection film 220 composed of Au is formed on the surface of the bump film 210. In this step, the backside of the substrate 100 is polished to have precisely the finished thickness thereof.

In a ninth step of the manufacturing method shown in FIG. 13, etching using a photoresist mask is performed on the surface protection film 200 and the surface insulating film 170 so as to form a through-hole H5 for exposing the etching stopper 161.

The film formation process regarding the surface of the substrate 100 is completed by way of the aforementioned steps. After completion of the film formation process of the surface of the substrate 100, a tenth step of the manufacturing method shown in FIG. 14 is performed in such a way that a photoresist mask R1 having a through-hole H6 is formed on the backside of the substrate 100 in order to form a through-hole corresponding to the cavity C1 in the substrate 100.

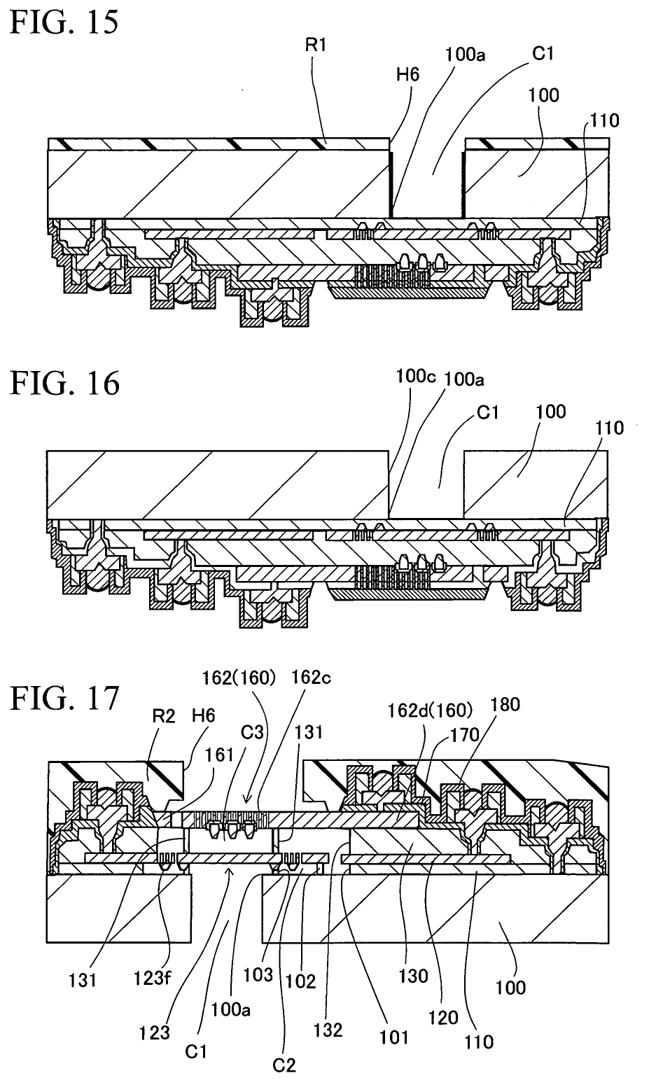

In an eleventh step of the manufacturing method shown in FIG. 15, the through-hole is formed in the substrate 100 by way of Deep-RIE, wherein the lower insulating film 110 serves as an etching stopper.

In a twelfth step of the manufacturing method shown in FIG. 16, the photoresist mask R1 is removed, and then an interior wall 100c of the through-hole of the substrate 200, which is initially formed with roughness due to Deep-RIE, is subjected to smoothing.

In a thirteenth step of the manufacturing method shown in FIG. 17, anisotropic etching using a photoresist mask R2 and BHF (i.e. dilute hydrofluoric acid) is performed so as to remove the excessive portions of the surface protection film 200 and the surface insulating film 170 positioned above the plate 262 and the plate lead 162d. In addition, the upper insulating film 130 is partially removed so as to form the ring portion 132, the plate spacers 131, and the gap C3. Furthermore, the lower insulating film 110 is partially removed so as to form the guard spacers 103, the diaphragm supports 102, the ring portion 101, and the gap C2. The BHF serving as an etchant enters via the through-hole H6 of the photoresist mask R2 and the opening 100a of the substrate 100. The outline of the upper insulating film 130 is defined by the plate 162 and the plate lead 162d. That is, the ring portion 132 and the plate spacers 131 are formed and defined in shapes thereof due to self alignment of the plate 162 and the plate lead 162d. As shown in FIG. 21, under-cuts are formed on the edges of the ring portion 132 and the plate spacer 131 by way of anisotropic etching. The outline of the lower insulating film 120 is defined by the opening 100a of the substrate 100, the diaphragm 123, the diaphragm lead 123d, the guard electrodes 125a, the guard connectors 125b, and the guard ring 125c. That is, the guard spacers 103 and the diaphragm supports 102 are formed and defined in shapes thereof due to self alignment of the diaphragm 123. As shown in FIGS. 21 and 22, under-cuts are formed in the edges of the guard spacer 103 and the plate spacer 131 due to anisotropic etching. In this process, the guard spacers 103 and the plate spacers 131 are formed, thus substantially forming the plate spacers 129 (except the guard electrodes 125a) for supporting the plate 162 above the substrate 100.

Lastly, the photoresist mask R2 is removed; then, the substrate 100 is subjected to dicing so as to completely produce a sensor chip of the condenser microphone 1 shown in FIG. 1. The sensor chip and the control chip are bonded onto the substrate of a package (not shown); then, wire bonding is performed to establish connections between terminals; thereafter, the substrate of the package is covered with a cover (not shown), thus completing the production of the condenser microphone 1. Since the sensor chip is bonded on the substrate of the package, the back cavity C1 (formed in the backside of the substrate 100) is closed in an airtight manner.

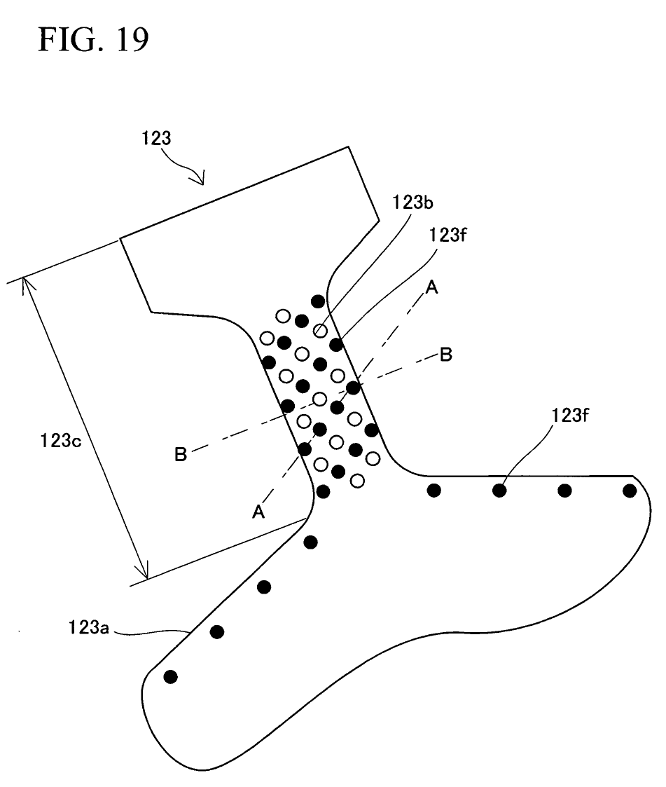

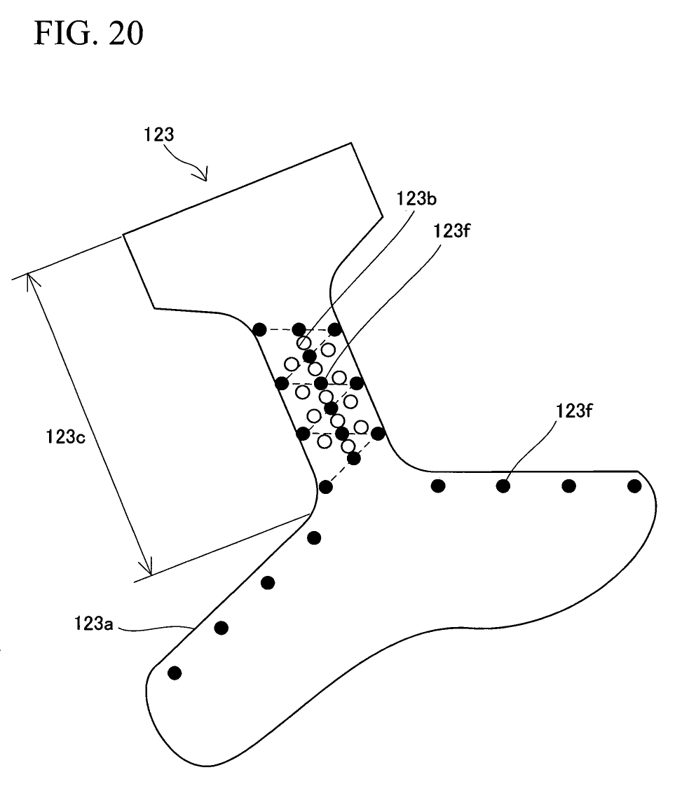

FIGS. 19 and 20 show variations regarding the alignment of the diaphragm bumps 123f in the arm 123c of the diaphragm 123, wherein the positions of the diaphragm bumps 123 are designated by black dots. In FIG. 19, the diaphragm bumps 123f are aligned in the arm 123c in a zigzag manner such that the line A-A connecting between one diaphragm bump 123f and a proximate diaphragm bump 123f thereof in the radial direction is inclined with the circumferential direction (i.e. the line B-B) of the diaphragm 123. In FIG. 20, the diaphragm bumps 123f are aligned in the arm 123c in such a way that lines connecting between the diaphragm bump 123f and their proximate diaphragm bumps 123f in the radial direction are drawn in a zigzag manner.

### 2. Second Embodiment

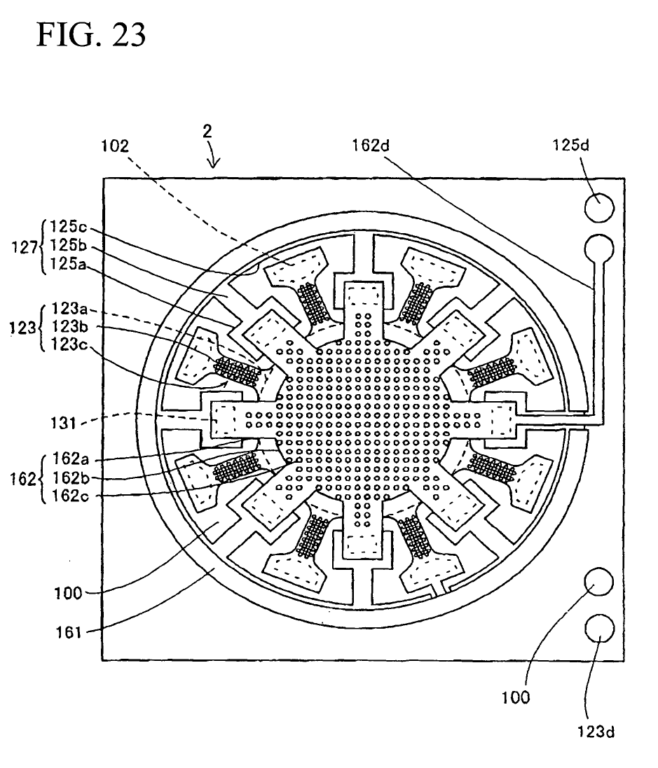

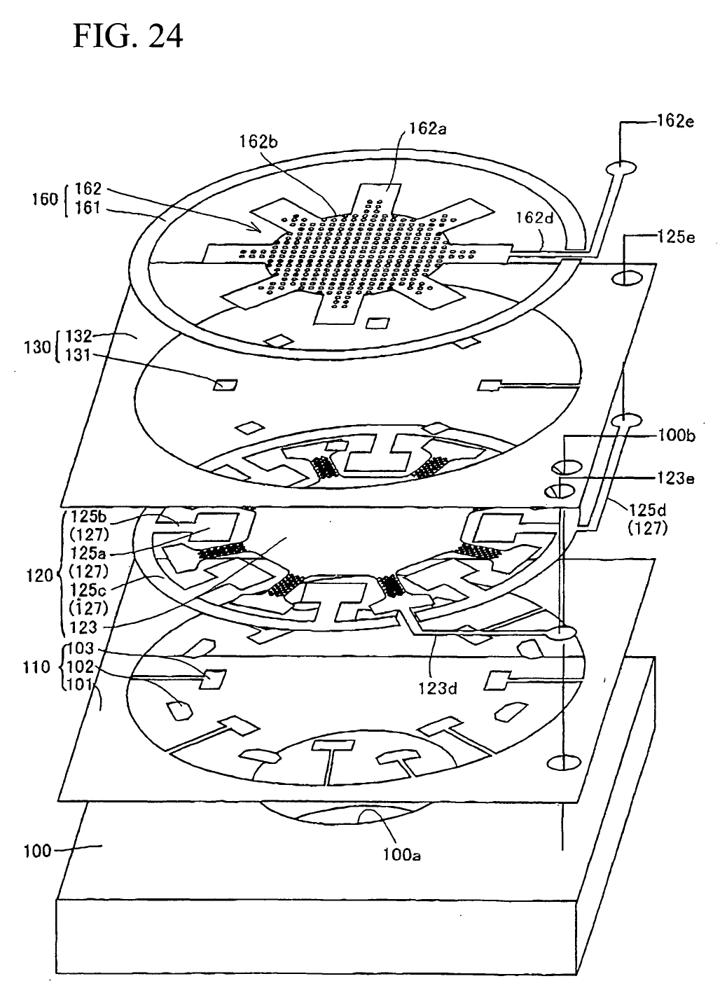

Next, a condenser microphone 2 according to a second embodiment of the present invention will be described with reference to FIGS. 23 to 31, wherein parts identical to those used in the condenser microphone 1 of the first embodiment shown in FIGS. 1 to 22 are designated by the same reference numerals; hence, the detailed constitutions and operations thereof will be described briefly.

FIG. 23 shows a sensor chip corresponding to an MEMS structure of a condenser microphone 2 of the second embodiment, the longitudinal sectional view of which is shown in FIG. 2. FIGS. 21 and 22 show cross sections of prescribed parts of the condenser microphone 2. The condenser microphone 2 is constituted of the sensor chip as well as a circuit chip (not shown) including power circuitry and amplification circuitry, and a package (not shown) containing these elements.

In a similar manner to the sensor chip of the condenser microphone 1 of the first embodiment, the sensor chip of the condenser microphone 2 of the second embodiment has the laminated and deposited structure including the substrate 100, the lower insulating film 110, the lower conductive film 120, the upper insulating film 130, the upper conductive film 160, and the surface insulating film 170. For the sake of simplicity, the upper layers formed above the upper conductive film 160 are not shown in FIG. 23. The lamination of films of the MEMS structure of the condenser microphone 2 will be described below.

The substrate 100 is composed of a P-type monocrystal silicon, which is not a restriction, wherein it is required that the material thereof should have certain rigidity, thickness, and strength for adequately supporting the base substrate (for depositing thin films, not shown) and the structure constituted of thin films. A through-hole is formed in the substrate 100, so that the opening 100a thereof forms the opening of the back cavity C1.

The lower insulating film 110 joining the substrate 100, the lower conductive film 120, and the upper insulating film 130 is a deposited film composed of silicon oxide (SiOx). The lower insulating film 110 forms a plurality of diaphragm supports 102 and a plurality of guard spacers 103 as well as the ring-shaped portion (which insulates the guard ring 125c and the guard lead 125d from the substrate 100).

The lower conductive film 120 joining the lower insulating film 110 and the upper insulating film 130 is a deposited film composed of polycrystal silicon entirely doped with impurities such as phosphorus (P). The lower conductive film 120 forms the diaphragm 123 and the guard 127 (constituted of the guard electrode 125a, the guard connector 125b, the guard ring 125c, and the guard lead 125d).

The upper insulating film 130 joining the lower conductive film 120, the upper conductive film 160, and the lower insulating film 110 is a deposited film composed of silicon oxide. The upper insulating film 130 forms a plurality of plate spacers 131 and the ring-shaped portion 132 which is positioned outside of the place spacers 131 so as to support the etching stopper 161, thus insulating the plate lead 162d from the guard lead 125d.

The upper conductive film 160 joining the upper insulating film 130 is a deposited film composed of polycrystal silicon entirely doped with impurities such as phosphorus (P). The upper conductive film 160 forms the plate 162, the plate lead 162d, and the etching stopper 161.

The surface insulating film 170 joining the upper conductive film 160 and the upper insulating film 130 is an “insulating” deposited film composed of silicon oxide.

The MEMS structure of the condenser microphone 2 has four terminals 125e, 162e, 123e, and 100b, which are formed using the pad conductive film 180, the bump film 210, and the pump protection film 220. The side walls of the terminals 125e, 162e, 123e, and 100b are protected from the surroundings by means of the pad protection film 190 and the surface protection film 200.

Next, the mechanical structure of the MEMS structure of the condenser microphone 2 will be described briefly.

The diaphragm 123 is constituted of the center portion 123a and a plurality of arms 123c. The “pillar” diaphragm supports 102 support the diaphragm 123, which is thus stretched in parallel with the substrate 100 with a gap therebetween and is insulated from the plate 162 with a gap therebetween. The diaphragm supports 102 are bonded onto the distal ends of the arms 123c of the diaphragm 123. Due to the cutouts formed between the adjacent arms 123c of the diaphragm 123, the diaphragm 123 may be reduced in rigidity compared with the foregoing diaphragm having no cutout.

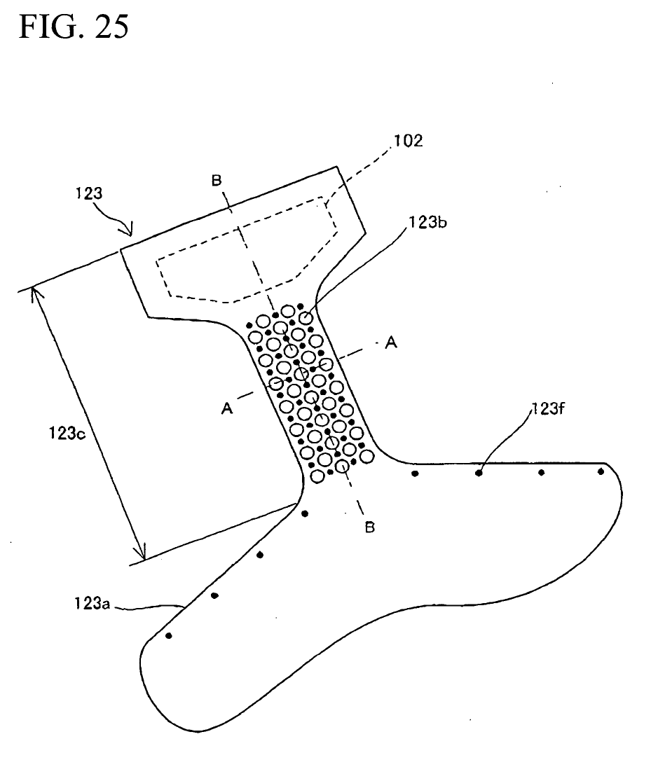

A plurality of diaphragm holes 123b is formed in the arms 123c, which are thus reduced in rigidity. In the arm 123c shown in FIG. 25, numerous diaphragm holes 123b are collectively aligned in a prescribed area, which is close to the center portion 124a rather than the joint area joining with the diaphragm support 102, whereby the prescribed area of the arm 123c (which is close to the center portion 123a rather than the joint portion joining with the diaphragm support 102) is formed in a net-like shape. Due to the net-like shape of the arm 123c, the arm 123c has a very low rigidity because the diaphragm holes 123 are closely aligned together such that the distance between the adjacent diaphragm holes 123b substantially matches the diameter of the diaphragm hole 123b.

Numerous diaphragm holes 123b (see white circles in FIG. 25) are aligned with equal spacing therebetween in both the radial direction (designated by the line B-B) and the circumferential direction (designated by the line A-A). That is, substantially the same distance is set between the adjacent two lines of the diaphragm holes 123b aligned in the circumferential direction, and substantially the same distance is set between the adjacent two lines of the diaphragm holes 123b aligned in the radial direction. Specifically, the diaphragm holes 123b aligned in the adjacent two lines aligned in the circumferential direction are not aligned in line in the radial direction of the diaphragm 123, so that they are alternately aligned in different lines in the circumferential direction of the diaphragm 123, in other words, they are aligned in a zigzag manner. This alignment of the diaphragm holes 123b, which are aligned with small distances therebetween, achieves a reduction of rigidity of the arm 123c while making it difficult to cause adherence even when the arm 123c is unexpectedly bent along the fold line(s) extending in the circumferential direction of the diaphragm 123.

The outline of the diaphragm 123 is a curve not having a bent portion between the center portion 123a and the joint portions at which the arms 123c join the diaphragm supports 102. This reduces a concentration of stress at the edges of the arms 123c in their width directions, and this makes it very difficult for the arms 123c to be broken irrespective of very high force being unexpectedly applied to the diaphragm 123. In addition, each of the arms 123c is expanded in size towards the center portion 123a in the circumferential direction of the diaphragm 123. This remarkably reduces a concentration of stress at the boundaries between the arms 123c and the center portion 123a.

A plurality of diaphragm supports 102 (having pillar shapes and insulating properties) is aligned with equal spacing therebetween in the circumferential direction of the opening 100a in the surrounding area of the opening 100a of the back cavity C1. The diaphragm 123 is supported above the substrate 100 via the diaphragm supports 102 such that the center portion 123a substantially covers the opening 100a of the back cavity C1. The gap C2 (see FIG. 2) substantially corresponding to the thickness of the diaphragm supports 102 is formed between the substrate 100 and the diaphragm 123. The gap C2 is required to establish a balance between the internal pressure of the back cavity C1 and the atmospheric pressure. The gap C2 is reduced in height but is increased in length in the radial direction of the diaphragm 123 so as to establish the maximum acoustic resistance in the path along which sound waves vibrating the diaphragm 123 are propagated to reach the opening 100a of the back cavity C1.

A plurality of diaphragm bumps 123f (see FIG. 2 and see black dots in FIG. 25) is formed on the backside of the diaphragm 123 positioned opposite to the substrate 100. The diaphragm bumps 123f are projections for preventing the diaphragm 123 from being unexpectedly attached (or adhered) to the substrate 100, wherein they are formed using the waviness of the lower conductive film 120 forming the diaphragm 123. For this reason, dimples (or small recesses) are formed on the diaphragm bumps 123f. In the arm 123c shown in FIG. 25, the diaphragm bumps 123f are positioned between the diaphragm holes 123b adjoining together.

The diaphragm 123 is connected to the diaphragm terminal 123e via the diaphragm lead 123d extended from the distal end of one of the arms 123c. The width of the diaphragm lead 123d is smaller than that of the arm 123c and is formed using the lower conductive film 120 (which forms the diaphragm 123). The diaphragm lead 123d is extended to pass through a gap of the guard ring 125c towards the diaphragm terminal 123e. Since the diaphragm terminal 123e and the substrate terminal 100b are short-circuited via the circuit chip (see FIGS. 4A and 4B), substantially the same potential is applied to both the substrate 100 and the diaphragm 123.

Even when the diaphragm 123 differs from the substrate 100 in potential, the parasitic capacitance formed between the substrate 100 and the diaphragm 123 becomes small because the diaphragm 123 is supported by the diaphragm supports 102 which adjoin together with an air layer therebetween in comparison with the foregoing condenser microphone whose diaphragm is supported by the spacer having a ring-shaped wall structure.

The plate 162, which is constituted of a single-layer deposited film having a conductive property, is constituted of the arms 162a each of which is extended in a radial direction from the center portion 162b. The plate 162 is supported by a plurality of plate spacers 162a (having pillar shapes) which are bonded at multiple points in proximity to the peripheral portion of the plate 162. The plate 162 is positioned in parallel with the diaphragm 123 such that the center of the plate 162 substantially matches the center of the diaphragm 123. The distance between the center of the plate 162 and the external end of the center portion 162b is shorter than the distance between the center of the diaphragm 123 and the external end of the center portion 123a. That is, the external portion of the diaphragm 123 (which causes relatively small vibration) is not positioned opposite to the external portion of the plate 162. Due to the formation of the cutouts between the arms 162a of the plate 162, the cutout regions of the plate 162 (which may match the external portion of the diaphragm 123) are not positioned opposite to the diaphragm 123. The arms 123c of the diaphragm 123 are extended in the cutout regions of the plate 162 in plan view. This increases the overall length of the diaphragm 123 without increasing the parasitic capacitance.

The plate holes 162c of the plate 162 serve as passages for propagating sound waves toward the diaphragm 123 and holes for transmitting the etchant (used for performing isotropic etching on the upper insulating film 130). The remaining portions of the upper insulating film 130 after etching are used to form the plate spacers 131 and the ring-shaped portion 162, while etched portions (or removed portions) of the upper insulating film 130 are used to form the gap C3 between the diaphragm 123 and the plate 162. That is, the plate holes 162c are through-holes that transmit the etchant to reach the upper insulating film 130 so as to simultaneously form the gap C3 and the plate spacers 131. For this reason, the plate holes 162c are appropriately arranged in consideration of the height of the gap C3, and the etching speed and the shape of the plate spacers 131. Specifically, the plate holes 162c are entirely formed in the arms 162a and the center portion 162b with equal spacing therebetween except for the joint areas of the plate 162 joining with the plate spacers 131 and surrounding areas. As the distances between the plate holes 162c adjoining together become small, it is possible to reduce the width of the ring-shaped portion 132 (formed using the upper insulating film 130), thus reducing the overall area of a chip. In this connection, the rigidity of the plate 162 becomes low as the distances between the plate holes 162c become small.

The plate spacers 131 join the guard electrode 125a (which is formed using the lower conductive film 120 forming the diaphragm 123), wherein they are formed using the upper insulating film 130 joining the plate 162. The plate spacers 131 are aligned with equal spacing therebetween in the surrounding area of the opening 100a of the back cavity C1, wherein they are positioned in the cutout regions between the arms 123c of the diaphragm 123 in plan view, so that the maximum diameter of the plate 162 becomes smaller than the maximum diameter of the diaphragm 123. This increases the rigidity of the plate 162 while reducing the parasitic capacitance between the plate 162 and the substrate 100.

The plate 162 is supported above the substrate 100 by means of a plurality of plate supports 129 which are constituted of multi-layered deposited films corresponding to the guard spacers 103, the guard electrode 125a, and the plate spacers 131. The plate supports 129 form the gap C3 between the plate 162 and the diaphragm 123, so that the gaps C2 and C3 are formed between the plate 162 and the substrate 100. Due to the insulating properties of the guard spacers 103 and the plate spacers 131, the plate 162 is insulated from the substrate 100.

A parasitic capacitance occurs in the region in which the plate 162 is positioned opposite to the substrate 100 when the potential of the plate 162 differs from the potential of the substrate 100, wherein it becomes high due to the existence of insulating materials positioned therebetween (see FIG. 4A). The second embodiment is designed such that the plate 162 is supported above the substrate 100 by means of the plate supports 129 (constituted of the guard spacers 103, the guard electrode 125a, and the plate spacers 131) which are isolated from each other. Therefore, even when the guard electrode 125a is excluded from the plate supports 129, it is possible to reduce the parasitic capacitance in the condenser microphone 2 in comparison with the foregoing condenser microphone in which the plate is supported above the substrate via the ring-shaped wall structure having the insulating property.

A plurality of plate bumps (or projections) 162f are formed on the backside of the plate 162 positioned opposite to the diaphragm 123. The plate bumps 162f are formed using the silicon nitride (SiN) film joining the upper conductive film 160 (forming the plate 162) and the polycrystal silicon film (joining the silicon nitride film). The plate bumps 162 prevent the diaphragm 123 from being unexpectedly attached (or adhered) to the plate 162.

The plate lead 162d whose width is smaller than the width of the arm 162a is extended from the distal end of the arm 162a of the plate 162 toward the plate terminal 162e, wherein it is formed using the upper conductive film 160 (forming the plate 162). Since the wiring path of the plate lead 162d overlaps with the wiring path of the guard lead 125d, it is possible to reduce the parasitic capacitance between the plate lead 162d and the substrate 100.

The overall operation of the condenser microphone 2 is substantially identical to that of the condenser microphone 1 (see FIGS. 4A and 4B); hence, the description thereof will be omitted.

The manufacturing method of the condenser microphone 2 is substantially identical to that of the condenser microphone 1 (see FIGS. 5 to 17); hence, the description thereof will be omitted.

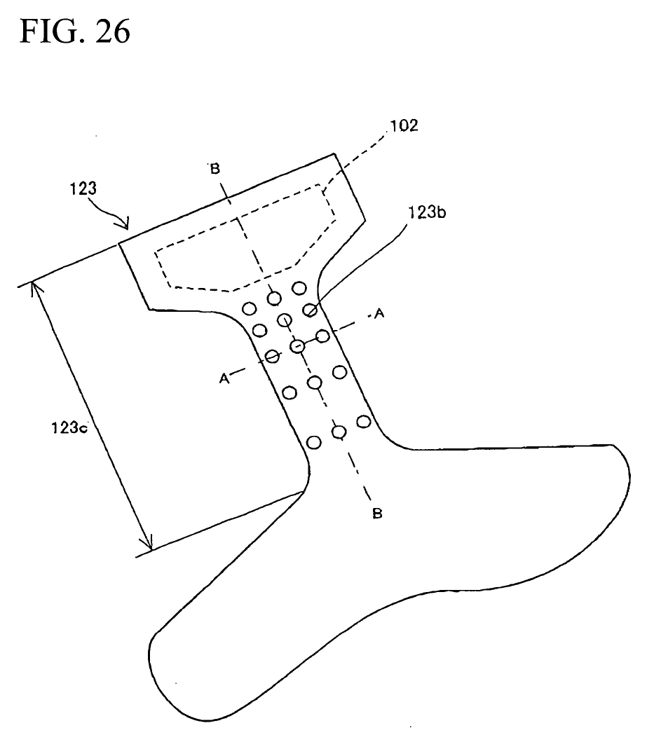

Next, variations of the condenser microphone 2 will be described with respect to the arm 123c of the diaphragm 123 with reference to FIGS. 26 to 31.

In order to reduce sharp variations of rigidity at the boundaries between the arm 123c and the center portion 123a of the diaphragm 123, the diaphragm holes 123b are aligned as shown in FIGS. 26 to 28 such that the density of the arm 123c increases in the direction from the joint portion joining with the diaphragm support 102 to the center portion 123a.

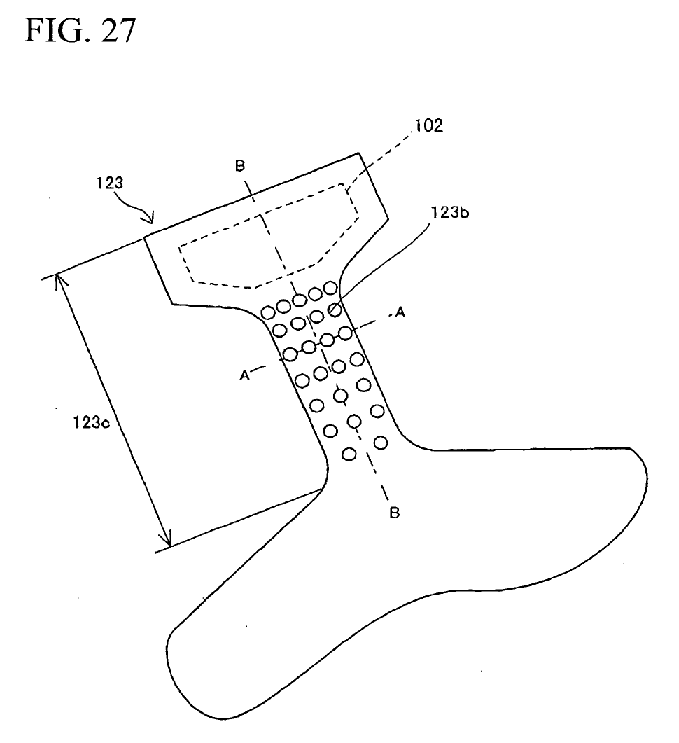

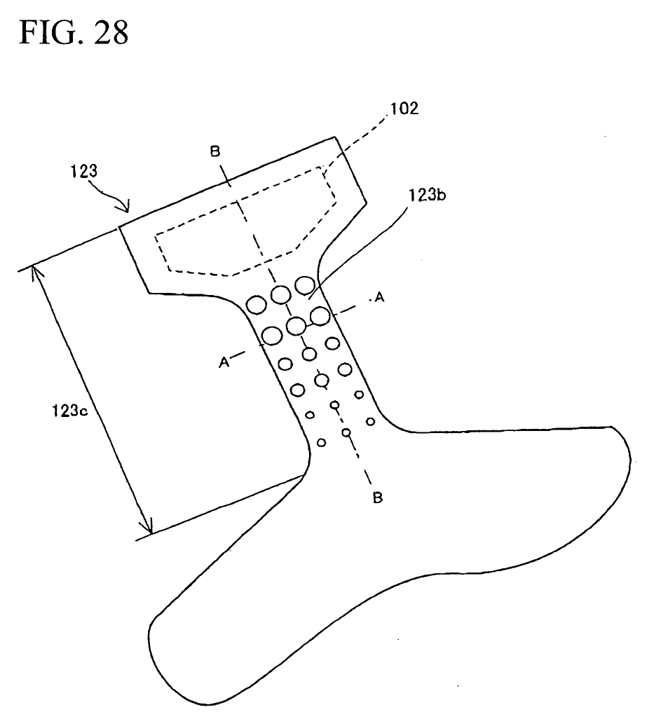

Specifically, FIG. 26 shows a first variation of the arm 123c of the diaphragm 123, in which the diaphragm holes 123b are aligned such that the distances between the diaphragm holes 123b adjoining in the radial direction (designated by the line B-B) gradually increase in the direction from the joint portion of the arm 123c joining with the diaphragm support 102 to the center portion 123a. FIG. 27 shows a second variation of the arm 123c of the diaphragm 123, in which the diaphragm holes 123b are aligned such that the number of the diaphragm holes 123b linearly aligned in the circumferential direction (designated by the line A-A) gradually decreases in the direction from the joint portion to the center portion 123a. FIG. 28 shows a third variation of the arm 123c of the diaphragm 123, in which the diameters of the diaphragm holes 123b gradually decrease in the direction from the joint portion to the center portion 123a.

By varying the distances, diameters, and shapes of the diaphragm holes 123b as described above, it is possible to reduce sharp variations of rigidity at the boundary between the arm 123c and the center portion 123a of the diaphragm 123.

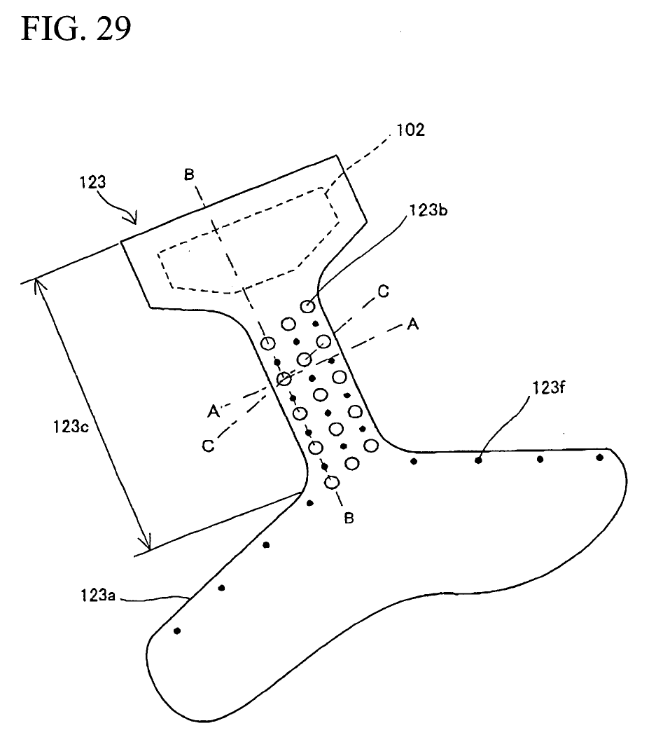

FIG. 29 shows a fourth variation of the arm 123c of the diaphragm 123, in which the diaphragm holes 123b are aligned in a zigzag manner such that the direction (designated by the line C-C) connecting between the diaphragm holes 123b, which are very close to each other in the radial direction (designated by the line B-B) of the diaphragm 123, is inclined to the circumferential direction (designated by the line A-A) of the diaphragm 123. Thus, a stripe-shaped region of the arm 123c which is reduced in rigidity is inclined to the circumferential direction of the diaphragm 123; hence, it is possible to prevent the arm 123c of the diaphragm 123 from being attached (or adhered) to the substrate 100 or the plate 162 even when the arm 123c is bent.

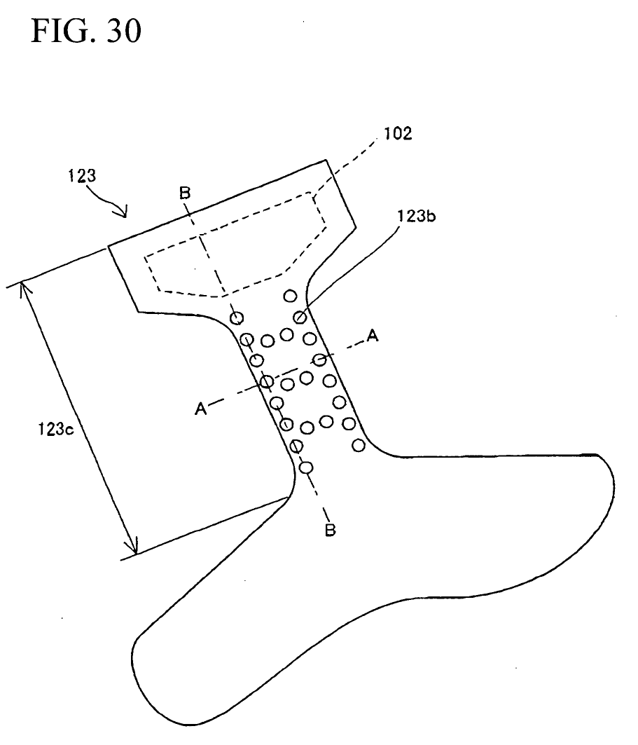

FIG. 30 shows a fifth variation of the arm 123c of the diaphragm 123, in which the diaphragm holes 123b are aligned such that the density of the arm 123c decreases in the direction from the center of the arm 123c in the circumferential direction (designated by the line A-A) to the edges of the arm 123c. For example, the diaphragm holes 123b are aligned such that the distances between the diaphragm holes 123b linearly adjoining in the radial direction (designated by the line B-B) decrease in the direction from the center of the arm 123c in the circumferential direction (designated by the line A-A) to the edges of the arm 123c. This reliably prevents the diaphragm 123 from being unexpectedly attached to the substrate 100 or the plate 162 even when the edges of the arms 123c are bent.

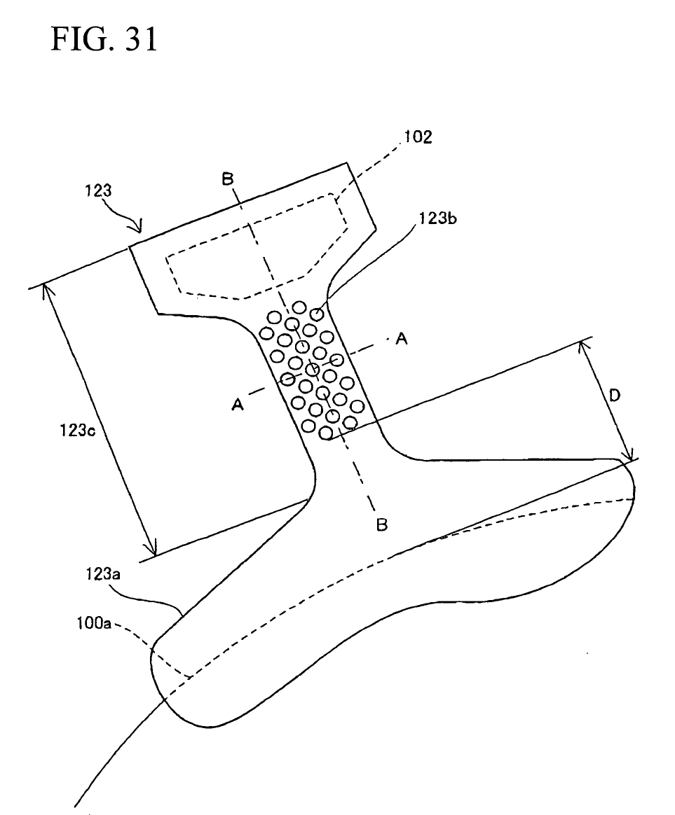

FIG. 31 shows a sixth variation of the arm 123c of the diaphragm 123, in which the diaphragm holes 123b are aligned such that no diaphragm hole is aligned in a prescribed area of the diaphragm 123 positioned in proximity to the opening 100a of the back cavity C1. That is, the length of a gap, which forms an acoustic resistance between the diaphragm 123 and the surrounding area of the opening 100a of the substrate 100 (corresponding to the back cavity C1), i.e., a length D lying in the radial direction of the diaphragm 123 shown in FIG. 31, becomes long in connection with the arm 123c rather than the center portion 123a.

In the first and second embodiments, materials and dimensions are merely illustrative and not restrictive, wherein the present description does not refer to the addition, deletion, and change of order of steps in manufacturing, which may be obviously understood by those skilled in the art, for the sake of simplification of explanation. In addition, film compositions, film formation methods, and methods for defining outlines of films as well as orders of steps in manufacturing can be appropriately determined in consideration of combinations of materials having desired properties, thicknesses of films, and required precisions for defining outlines of films; hence, they are not necessarily limited by the description.

Lastly, the present invention is not necessarily limited to the embodiments and variations, which can be further modified in a variety of ways within the scope of the invention as defined by the appended claims.

What is claimed is:

1. A vibration transducer comprising:
a substrate;
a diaphragm, which is formed using a deposited film having a conductive property positioned above the substrate and which has a plurality of arms extended from a center portion in a radial direction;
a plate, which is formed using a deposited film having a conductive property positioned above the substrate;
a plurality of diaphragm supports, which is formed using a deposited film positioned above the substrate and which joins the plurality of arms so as to support the diaphragm above the substrate with a prescribed gap therebetween; and
a plurality of diaphragm bumps, which is formed to project from the plurality of arms so as to prevent the diaphragm from being unexpectedly adhered to the substrate or the plate,
wherein when the diaphragm vibrates relative to the plate, an electrostatic capacitance therebetween is varied so as to detect variations of pressure applied thereto.

2. A vibration transducer according to claim 1, wherein the plurality of diaphragm bumps is formed in proximity to edges of the arm of the diaphragm in its circumferential direction.

3. A vibration transducer according to claim 1, wherein the plurality of diaphragm bumps is aligned in the arm in such a way that a line connecting between one diaphragm bump and its proximate diaphragm bump thereof in a radial direction is inclined about the circumferential direction of the diaphragm.

4. A vibration transducer according to claim 1, wherein the plurality of diaphragm bumps is aligned in a zigzag manner in the arm.

5. A vibration transducer according to claim 1, wherein each of distal ends of the diaphragm bumps is not formed in a sharp shape.

6. A vibration transducer comprising:
a substrate;
a diaphragm, which is formed using a deposited film having a conductive property positioned above a substrate and which has a plurality of arms extended from a center portion in a radial direction;
a plate, which is formed using a deposited film having a conductive property positioned above the substrate;
a plurality of diaphragm supports, which is formed using a deposited film positioned above the substrate and which joins the plurality of arms so as to support the diaphragm above the substrate with a prescribed gap therebetween; and
a plurality of plate bumps, which is formed to project from a peripheral portion of the plate so as to prevent the diaphragm from being unexpectedly adhered to the plate,
wherein when the diaphragm vibrates relative to the plate, an electrostatic capacitance therebetween is varied so as to detect variations of pressure applied thereto.

7. A vibration transducer according to claim 6, wherein each of distal ends of the plate bumps is not formed in a sharp shape.

8. A vibration transducer comprising:
a diaphragm having a conductive property, which is constituted of a center portion and a plurality of arms extended in a radial direction from the center portion;
a plate having a conductive property, which is positioned opposite to the diaphragm;
a plurality of diaphragm supports each having an insulating property, wherein the diaphragm supports join the arms so as to support the diaphragm while forming a gap between the diaphragm and the plate; and
a plurality of holes, which is formed in each of the arms of the diaphragm,
wherein when the diaphragm vibrates relative to the plate, an electrostatic capacitance formed between the diaphragm and the plate is varied, thus detecting vibration.

9. A vibration transducer according to claim 8, wherein the plurality of holes is aligned in each of the arms of the diaphragm such that a density of each arm gradually increases in a direction from a joint portion of the arm joining with the diaphragm support to the center portion of the diaphragm.

10. A vibration transducer according to claim 8 further comprising a substrate having an opening forming a back cavity with the diaphragm, wherein the plurality of diaphragm supports joins a surrounding area of the opening of the substrate, wherein the center portion of the diaphragm substantially covers the opening of the substrate with a gap therebetween, and wherein the plurality of holes is formed in each arm except for a prescribed area positioned in proximity to the opening of the substrate.

11. A vibration transducer according to claim 8, wherein the plurality of holes is aligned such that a line connecting between the holes adjoining in a radial direction of the diaphragm is inclined to a circumferential direction of the diaphragm.

12. A vibration transducer according to claim 8, wherein each arm is reduced in density in a direction from a center of each arm in a circumferential direction of the diaphragm to edges of each arm.

13. A vibration transducer according to claim 8, wherein at least a part of an area of each arm which is close to the center portion of the diaphragm compared with a joint portion joining together with the diaphragm support is formed in a net-like shape.
